(19) United States
(12) Patent Application Publication
(10) Pub. No.: US 2004/0123716 A1
(43) Pub. Date: Jul. 1, 2004

(54) Dual function cutting guide plate member for hand held power tools

(76) Inventors: Roger Oliva Durand, Calgary (CA); James David Oshanek, Calgary (CA)

Correspondence Address: ROGER DURAND, c/o Trim-Tech Finishing Ltd, 148 RIVERGLEN DRIVE SE, CALGARY, AB, T2C 4E2, CA

(21) Appl. No.: 10/329,928

(22) Filed: Dec. 27, 2002

(51) Int. Cl. B26D 5/08; B27B 5/00

(52) U.S. Cl. 83/743

(57) ABSTRACT

A portable, adjustable straight edge cutting guide plate of symmetrical longitudinal design to use in conjunction with hand held portable power tools. The plate is designed to provide use with two different hand held power tools using a single guide plate. The cutting guide plate is the integral part of a three-member system complete cutting guide. The guide plate is designed with slotted inset nut and bolt members; this system allows the user the freedom to remove and transfer the guide plate to a multitude of baseplates thus creating limitless possibilities for use as a cutting guide for different hand held power tools of different makes and models.

### BACKGROUND OF THE INVENTION

1. Field of the Invention

The present invention relates to the first member (“A-part”) of a portable complete cutting guide for hand-held power tools and more particularly pertains to such a thin, removable plate member apparatus of longitudinal shape and symmetrical design with two raised straight edge guide lips and an adjustable nut & bolt system for securing the apparatus to a chosen rigid baseplate (“B-part”) material, the present invention is the first part of a three-part system that when assembled forms a complete, adjustable cutting guide platform of which does not require clamping in order to make accurate cuts with precision to a work piece with a power circular saw, jigsaw, router or spiral cutting saw; a cutting guide of which can be easily moved to and about a work piece to be cut. The present invention when mounted to a rigid baseplate material forms the essential elements of the cutting guide; the third part of the system requires the user to affix non-skid tape strips (“C-part”) to the dual underside edges of the baseplate applied in the lengthwise cutting direction.

The assemblage of all of these elements forms the complete cutting guide; a complete cutting guide that has two perfectly straight edges to adapt to different hand held power tools; a complete cutting guide that has the present invention secured to the baseplate by way of a nut and bolt system designed to be adjustable and enabling the user to remove freely the present invention and affix to multiple baseplates to accommodate many different portable hand held power tools of different makes and models; a complete cutting guide that is portable in function and able to be moved freely on and about a work piece to be cut; a complete cutting guide that provides a stable platform to operate the portable hand held power tool; a complete cutting guide that provides a stable platform of which enables the user of a hand held power tool to maintain perpendicular plane between the cutting blade and the work piece material; a complete cutting guide that provides the user a visual cutting guide edge, one that is created by the first initial cut of the power tool through the baseplate material (once the present invention has been affixed to the baseplate); a complete cutting guide that has non-skid tape applied to the underside edge of the newly formed cutting blade edge of the baseplate; a complete cutting guide that contacts a work piece to be cut directly by way of the non-skid tape and forms a non-damaging frictional function that grips the surface of the work piece to be cut essentially eliminating the need to use clamps to maintain contact between the cutting guide and the work piece to be cut, thus enabling the user to cut work pieces of small dimension.

Conventional cutting guides now available require the user the clamp the cutting guide to the work piece; the user must measure the distance of between the cutting blade and the peripheral guide surface edge of the power saw housing. The need to clamp existing conventional cutting guides limits, 1) the size of work piece materials that can be cut; 2) the maneuverability of hand held power saw about the work piece to be cut; and 3) the speed of which the user can adjust the cutting guide to make new cuts. The complete combination of the present invention/baseplate/non-skid tape allows the operator of hand held power tools such as hand held power circular saw to cut work piece materials securely with tremendous accuracy and precision and all in a timely manner due to the lack of preparation setting clamps. The said complete combination enables the operator of the aforementioned hand held power tools to: make straight cuts to work piece materials of long length; make cuts to work piece materials of very small dimension that would otherwise be impossible to cut with any other existing power tool hand held or otherwise; to makes cuts to work piece material such as Plywood and minimize chipping to the cut edge.

2. Description of the Prior Art

The use of cutting guides is known in the prior art. More specifically, such guides heretofore devised and utilized for the purpose of cutting wood panels or the like are known to consist basically of familiar, expected and obvious structural configurations, notwithstanding the myriad of designs encompassed by the crowded prior art which have been developed for the fulfillment of countless objectives and requirements. Typical guides are shown in U.S. Pat. Nos.: 4,075,920; 4,453,438; 4,539,881; and 5,365,822.

In this respect, the cutting guide according to the present invention substantially departs from the conventional concepts and designs of the prior art, and in so doing provides an apparatus primarily developed for the purpose of the following: providing a guide plate member that is of symmetrical design and through such symmetry of design provides two raised guide lips of which function as the straight edge guide for which the peripheral guide edge of hand held power tools to follow (circular power saw, router, jigsaw, and spiral cutting saw; all of different makes and models); providing a guide plate member that can be easily secured and removed from the baseplate by way of a “washerless” slotted nut and bolt member that is designed to allow for minor adjustments and to provide the means to freely remove the guide plate member to transfer to a new baseplate member to perform in conjunction with a multitude of hand held power tools; a guide plate member (when mounted in combination with the baseplate member affixed with the non-skid tape member applied to the under-edge surface of the cutting blade edge) that is made of rigid, non-splitting material (plastic) and light enough to be easily portable to be easily positioned on and about a work piece to be cut.

The complete cutting guide apparatus will exhibit the ability to hold down the edge of a work piece to be cut without the use of clamps while minimizing chipping thereof; dual function through symmetry of design allows for multiple power tool usage; the ability to cut work pieces of very small dimension; and the ability to maneuver the apparatus for any angle of cut that would otherwise be impossible or very difficult to cut. The present invention departs substantially from all present cutting guides available to the consumer in both function and design.

Therefore, it can be appreciated that there exists a need for a new and improved multi-tool cutting guide that it adjustable and adaptable to multiple power tool. In this regard, the present invention substantially fulfills this need.

### BRIEF SUMMARY OF THE INVENTION

In view of the foregoing disadvantages inherent in the known types of cutting guides now present in the prior art, the present invention provides an improved cutting guide combination which is adjustable and wherein the same portable cutting guide device can be utilized with multiple portable hand power tools. As such, the general purpose of the present invention, which will be described subsequently in greater detail, is to provide a new and improved cutting guide with the ability to adapt to multiple hand held power tools without the use of clamps while enabling the user to cut very small work pieces that would otherwise be impossible to cut with such power tools and cuts of which would be restricted to cutting by non-powered, hand held wood crafting tools. The present invention is able to adapt to multiple hand held power tools by way of: 1) the dual raised guide edges and 2) the nut and bolt system of which allows the user the freedom to remove and transfer the present invention to multiple baseplates all of which can be customized to fit all makes and models of hand held powered: circular saws, routers, jigsaws and spiral cutting saws. The present invention has all the advantages of the prior art devices and none of the disadvantages.

To attain this, the present invention essentially comprises a thinly designed plate member of which has two symmetrical raised straight edge guide lips and an anchoring nut and bolt system of which is adjustable; this plate member apparatus is to be anchored to a rigid baseplate whereby the baseplate is next cut by a cutting blade of a hand held power tool such as: circular saw, a jig saw, router or spiral cutting saw. The two raised straight edges act as the contact guide edges whereby the peripheral guide edge housing the cutting blade will follow. The applied pressure of the peripheral housing along the raised guide lips will ensure that the cutting blade is kept in perfect position along the cutting mark and in the perpendicular plane in relation to the work piece to be cut. The raised guide edges of the present invention do not come in direct contact with the cutting blade edge and therefore will never get damaged through proper care and use and will always remain perfectly straight. The symmetry of the designed two raised guide edges allows for the user to utilize two different hand held power tools with a single cutting guide. The nut and bolt system is an inset groove member that is positioned perpendicular to and between the two raised straight edges; the nut is a square nut member; the inset slotted groove has two parts: an upper portion that is the exact dimensional width of the square nut member and a lower portion that is equal to the cross-diameter of the bolt thread member. The difference in dimensional width of the upper and lower portion of the slotted member in essence creates a fixed washer and provides the “anchor” required for securing the present invention to a rigid baseplate material.

Once the present invention is mounted to a baseplate, the next step is to customize the cutting guide to fit the user's chosen hand held power tool.

This is accomplished by making a single pass with the cutting blade while holding the peripheral guide of the tool against the raised guide lip of the present invention. The newly cut edge forms a marker for which the user can visually align to make future cuts. The next step in making the complete cutting guide is to now secure two strips of non-skid tape applied directly to the underside length of the newly cut edge; this allows the user to apply the function of the cutting guide to a work piece to be cut without the use of any clamping devices; cut at any angle of degree; minimize chipping of the cut edges on cuts made cross-grain on Plywood, doors, laminate or the like thereof. Through simple application of hand pressure, the cutting guide is held securely to the surface of the work piece to be cut in essence acting as clamp; the non-skid tape is non-damaging to the surface of the work piece to be cut. The lack of clamps does not inhibit the size of work piece material to be cut thus allowing the ability for the user to make cuts to very small work pieces that would otherwise be impossible to cut with a power tool by any other means.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide an integral device that forms the base for the development of a new and improved cutting guide that has all the advantages of the prior art devices and none of the disadvantages.

It is another object of the present invention to provide a device of which is easily removable and transferable thus creating a cutting guide that has maximized potential for universal adaptation to hand held power tools such as: circular saws, routers, jigsaws and spiral cutting saws.

It is another object of the present invention to provide an innovative device that enables the assemblage of a new and improved cutting guide that may be easily and efficiently manufactured and realistically marketed.

It is a further object of the present invention to provide a new and improved cutting guide that is capable of universal adaptation with a multitude of hand held power tools and is of a durable and reliable construction.

An even further object of the present invention is to provide a new and improved cutting guide which is susceptible of a low cost of manufacture with regard to both materials and labor, and which accordingly is then susceptible of low prices of sale to the consuming public, thereby making such devices economically available to the buying public.

Still yet another object of the present invention is to provide a new and improved cutting guide which provides in the apparatuses of the prior art some of the advantages thereof, while simultaneously overcoming some of the disadvantages normally associated therewith.

Still another object of the present invention is to provide a new and improved cutting guide especially useful for cutting numerous building materials such as: lumber, MDF building products, Plywood, paneling, shelving, door trimming, ETC.

Yet another object of the present invention is to provide a new and improved cutting guide which: does not require clamping; is lightweight; is easily portable; is maneuverable about a work piece to be cut; and is easy to store.

Even still another object of the present invention is to provide a new and improved cutting guide that provides to the user of such the ability to make accurate and precise straight cuts when using portable hand held power tools.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE SEVERAL VIEWS OF THE DRAWING

FIG. 1 shows the design of the present invention or cutting guide plate member; shown are the two raised straight edges or guide lips; also shown are the two inset slotted nut and bolt members of the present invention and the lower ledge members of the slotted groove member upon which the square nut member is supported and rests.

FIG. 5 is a perspective view of the present invention shown as it would be anchored to a baseplate; note the dual raised straight guide lips.

FIG. 8 is an overhead view showing the nut and bolt member; illustrated is the square nut member and the lower ledge member of the inset slotted groove. The lower ledge member supports the square nut member and acts as a washer for the nut and bolt assembly.

FIG. 9 is an overhead view showing a typical power circular saw in position on the platform of the baseplate; note the position of the peripheral guide edge of the power tool in relation to the raised straight edge guide lip of the present invention.

FIG. 13 is an overhead view showing a typical hand held jigsaw in position on the platform of the baseplate; note that the other raised straight edge is used as that of the power circular saw, demonstrating the duality of function of the designed present invention.

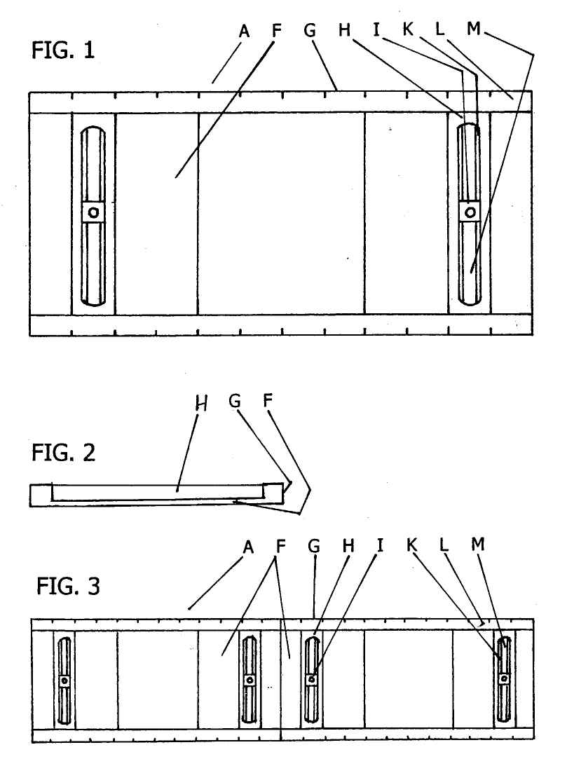

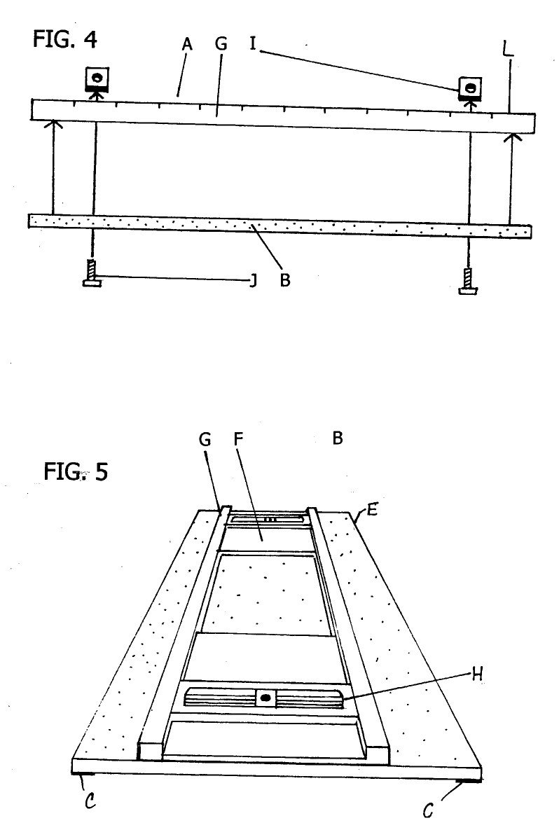

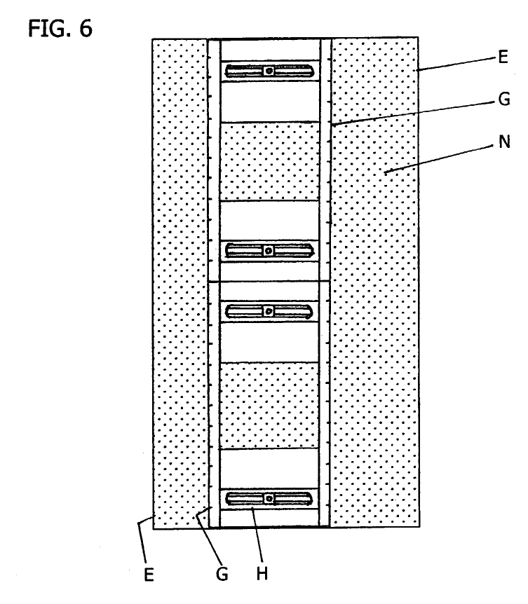

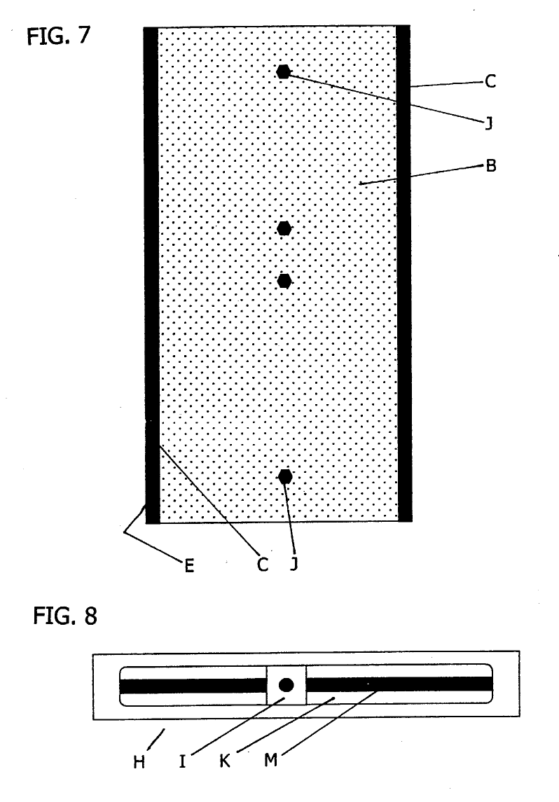

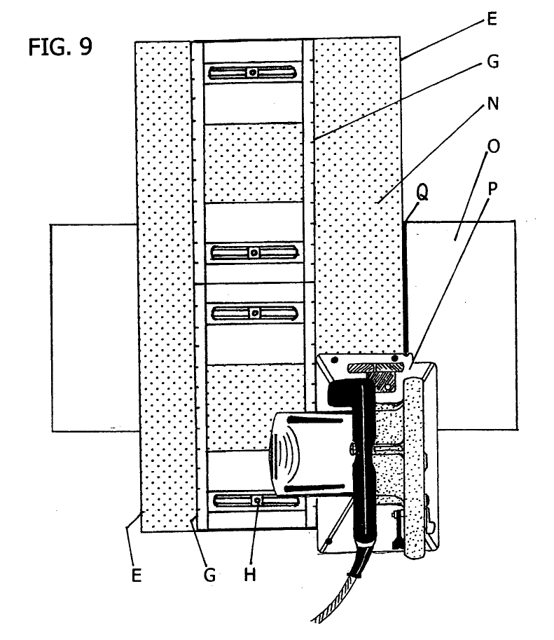

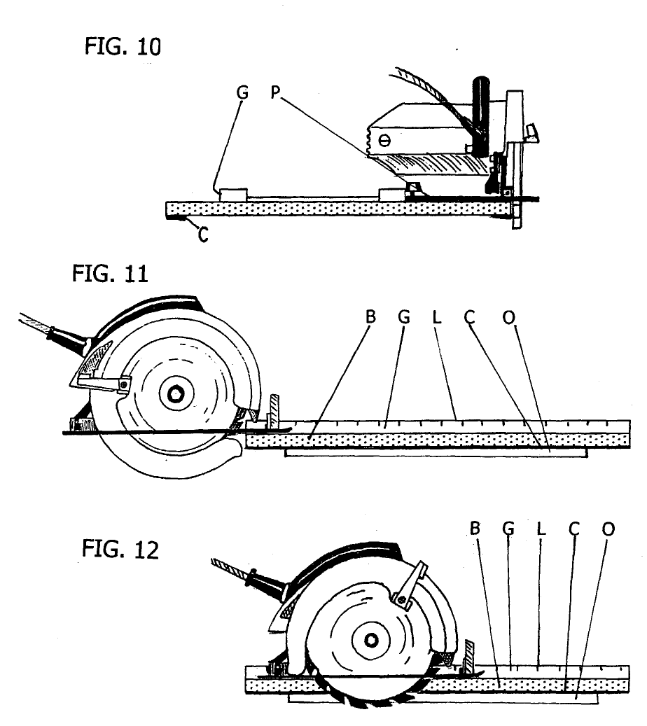

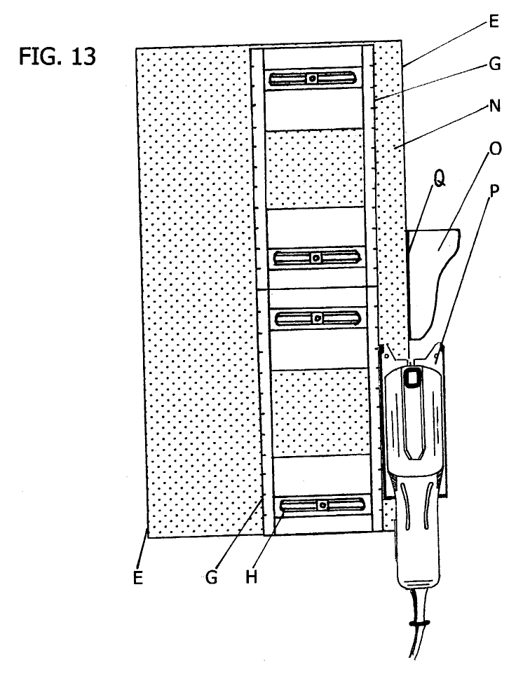

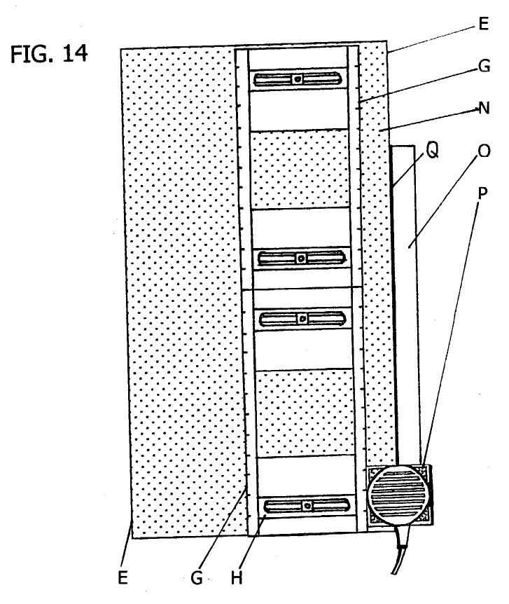

### DETAILED DESCRIPTION OF THE INVENTION

The present invention is the cutting guide plate member and is the integral “A-part” of a three-member system complete cutting guide member of symmetrical U-shaped design running along the longitudinal axis. The said present invention (A-part) has three main features: those being 1) symmetrical U-shaped longitudinal design, 2) two raised straight edge guide lips and 3) an inset slotted nut and bolt member of which allows a square nut member to flow freely in a slotted groove but is held in place by a ledge member of which acts as a restrictive washer and does not allow the square nut to pass through the groove.

The body of the said present invention is to be constructed from thin, lightweight yet durable plastic material; the two raised straight edge guide lips form the “U” of the design. The said present invention is perfectly symmetrical along the longitudinal axis and perfectly symmetrical along the lateral axis. The said two raised straight edge guide lips form the area of contact for which the peripheral guide edge of a chosen hand held portable power tool may be applied thereto. The said two raised straight edge guide lips will be manufactured to be of certain rigidity and reinforced in order to maintain and ensure that the straight edges will not bend or bow when subjected to applied pressure from the user of the assembled cutting guide.

The said inset slotted nut and bolt member is designed to function as an adjustable, semi-permanent anchoring system of which allows the said present invention to be attached to multiple baseplates (B-part of the said complete cutting guide). The nut member of said slotted nut and bolt member is a square nut; the bolt member is one that can be easily counter sank to be even with the under surface of the said baseplate. The said slotted nut and bolt member is an elongated groove and is positioned between the said two raised straight edge guide lips in a perpendicular fashion; the said elongated groove of the said inset slotted nut and bolt member consists of two parts: 1) the width of the upper half of the said elongated groove is equal in distance to the width of the said square nut member and 2) the lower half of the said elongated groove is indents along both sides equal in width to the diameter of the threaded body of the said bolt member, more simply creating a ledge or fixed washer for which the said square nut can be tightened against in order to securely anchor the said present invention to the said baseplate.

The said present invention is anchored to a baseplate (B-part) whereby two strips of non-skid tape (C-parts) are next adhered to the underside-edge of the said B-part after the newly formed “cutting blade marker edge”. The said present invention attaches to a said B-part by an adjustable, sliding nut & bolt system. The said A-part provides two distinct raised straight guide lips for the guide-plate of any circular power saw, jigsaw, router or spiral cutting saw. Also, the said A-part has a visually marked ruler running length-wise along the top visual of the two guide lip edges. The said cutting blade marker edge is formed by making one initial pass on the baseplate with the cutting blade of the chosen hand held power tool; this action trims the baseplate to custom fit to the distance between the cutting blade and the peripheral guide edge of the chosen hand held power tool. This is important to the design of the complete cutting guide as the said cutting blade marker edge forms the line whereby the cutting blade will cut a work piece to be cut. Simply, the said cutting blade marker edge can now be used as a visual reference to match with the marker of a work piece to be cut. The said C-part strips can next be affixed to the underside-edge of the said B-part along the said cutting blade marker edge in the direction of the longitudinal cutting plane.

The assembly of the said present invention/B-part/C part together form a new said complete cutting guide that is the “ultimate portable cutting guide”; a guide that is easy to maneuver about any work piece to be cut.

The said complete cutting guide provides the user with a stable platform surface of which keeps the cutting blade in a perfect perpendicular position in relation to the work piece to be cut. The said cutting blade marker edge serves as the visual cut marker for which the operator will use to align future cuts to be made when using the said complete cutting guide. Also, the said cutting blade marker edge can be customized to allow the user of a power circular saw to cut any angle of degree between zero and forty-five degrees to make miter cuts. The said non-skid tape strips provide non-damaging frictional grip to the surface of the work piece to be cut thus eliminating the need for cumbersome and time-consuming clamps; clamps of which significantly restrict the size and dimension of the work pieces that can be cut.

The said present invention is to be manufactured in the form of thin, lightweight yet durable plastic thus creating a low friction contact surface for which the metallic or plastic peripheral guide plates of the aforementioned power tools to follow along the raised straight edge guide lips of the said present invention. The said present invention is anchored to the said B-part by way of an adjustable nut and bolt system to a recommended said baseplate material of certain rigidity. The said baseplate must be of certain rigid material of which can be cut or trimmed by the chosen power tool (preferably wood-based) to add the supporting strength to the assembled said complete cutting guide. No clamping to the work piece will be required to operate with a circular saw or jigsaw. Some clamping may be required to operate some models of router that require both hands to operate. The said present invention is not limited to a single said B-part by way of the design of the nut & bolt attachment system of which allows for the said present invention to be easily removed from the said B-part and anchored to a new said baseplate in order to accommodate different hand held portable power tools.

This said complete cutting guide addresses 3 issues of concern when operating hand held power tools; firstly: clamping—all currently marketed cutting guides of which we are aware, require clamping; second: precision and accuracy—it is incredibly difficult to make straight cuts with any degree of precision without the use of a guide; third: safety—the platform surface of the guide provides safety through stability and equilibrial balance of the cutting blade in relation to the work piece to be cut, henceforth eliminating the potential for “binding” of the cutting blade during the cutting process. Many portable power tools are easy to maneuver but difficult to control with any precision; the design of the present invention provides the user with a an easy to use portable cutting guide enabling the user to make cuts on work pieces of all shapes, sizes and of minimal lengths in a secure fashion. The ability to cut single work pieces of very small dimension or the option to cut multiple small work pieces of small dimension is unique to the present invention; the ability to operate two different power tools with a singular cutting guide and the ability to interchange baseplates are also unique to the function of the present invention.

What is claimed is:

1. (original) A versatile, elongated cutting guide plate for use with multiple mounted baseplates and multiple hand held portable power tools comprising:
An apparatus that functions as the cutting guide plate member (“A-part” or present invention) comprised of a symmetrical, U-shaped design running along the longitudinal axis. Each of the upturned “U” legs of the apparatus acts as the raised straight edge guide lip for the chosen portable cutting power tool (power circular saw, jigsaw, router and spiral cutting saw). The design of the said present invention is perfectly symmetrical along the longitudinal axis and perfectly symmetrical along the lateral axis. The said present invention will be manufactured from thin, lightweight plastic of durable construction. The said raised straight edge guide lips form the perfectly straight, low-friction cutting guide edges for which the peripheral guide plate edge that houses the cutting blade for which the aforementioned hand held power tools can easily follow when guided in the longitudinal cutting direction.
An elongated flat running “body” portion of said cutting guide plate member must be at least 4 inches in width to serve as a resting brace for users to apply hand pressure when using. The upturned height of the “U” portion will be no more than ⅜″ to allow for maximum cutting blade depth and maximum clearance for the power tool motor assembly. The base longitudinal length of the cutting guide plate member is 12 inches and will likely be manufactured in linear lengths evenly divisible by 12 inches.
An apparatus with a design “body” that will be secured to a baseplate (B-part) of equal elongated length of the guide by an adjustable nut & bolt system mounted in an inset slotted member; the baseplate extend laterally wider than the width of the said cutting guide plate member; the distance of extension is dependant upon the measured distance from the cutting blade and the fixed guide edge of the said chosen portable cutting power tool, the baseplate extension must be wider than this measured distance. This enables the complete cutting guide to be universal in application with the said chosen portable cutting power tools. Materials such as Plywood, hardboard and MDF have the necessary rigidity required for the baseplate of which to mount the said present invention.
Once the said A & B parts are joined together, a non-skid tape strip (C-part) must be mounted to the underside of the said B-part along the newly formed cutting blade guide edge(s) along the cutting direction length of the said baseplate. The assemblage of all A, B & C parts forms a new complete cutting guide. The said C-part forms a non-damaging frictional support function for engagement of the said complete cutting guide to the work piece to be cut.
The said complete cutting guide provides a stable platform and perfectly straight cutting edge for the power tools aforementioned. A said complete cutting guide that is both versatile and adjustable in function, easy to maneuver about any work piece to be cut, and able to securely hold the smallest of work piece material without the use of any clamps.
The A-part mounts to the B-part by way of a nut & bolt system that is secured in elongated inset slot to allow for (1) adjustments to the new cutting edge and (2) the ability to detach said A-part from said B-part forming a new said complete cutting guide for a different power tool. The said inset slotted member is designed in such a way to act as a “washerless” system for the nut and bolt.

2. (original) A cutting guide according to claim 1, wherein the said present invention is the integral piece of a said complete cutting guide of which is attached to a said baseplate member of which is formed of a material capable of being cut by the said chosen portable cutting power tool and whereby said baseplate member can be cut by the blade of the said chosen portable cutting power tool so as to define a new cutting blade marker edge side of said baseplate member characterized by a distance between said new cutting blade marker edge side created and said raised straight edge guide lip of said present invention member being equal to the distance between said chosen portable cutting power tool's guide edge and the cutting blade edge perimeter of said chosen portable cutting power tool. The distance between the said new cutting blade marker edge and the said raised straight edge guide lip of the said present invention forms a platform surface on the said baseplate on which the body of the guide plane of the chosen portable cutting power tool is supported; a said platform of which provides a cutting plane that is perpendicular to the surface of a work piece to be cut.

3. (original) A cutting guide according to claim 1, whereby the said present invention has said two raised straight edge guide lips of which are perfectly straight and run along the longitudinal axis. This allows the said present invention to function with two different hand held portable power tools with use of a single said baseplate without making any adjustments to change tools; for example one side can be adapted for use with a power circular saw and the opposing side can be custom fitted for use with a jigsaw. The upper, visually seen part of each said raised straight edge guide lips will have visible a ruler member in place of which benefits the user of the cutting guide.

4. (original) A cutting guide according to claim 1, whereby said complete cutting guide is created by using the said present invention as the integral apparatus to form a said cutting blade marker edge, the bottom-side of both said cutting blade marker edges next requires a non-skid mounted tape or an anti-slip surface to be applied longitudinally along the newly formed said cutting blade marker edge(s) or along the non-cut opposing longitudinal edge of the bottom baseplate if dual function is not being used. The said non-skid tape strips maintain non-damaging surface contact grip with the work piece to be cut. This assemblage of the said present invention/said baseplate/said non-skid tape strips form the complete cutting guide. The said complete cutting guide provides to the user a safe platform that grips any work piece to be cut without the using cumbersome clamping devices. The said newly formed cutting blade marker edge of said baseplate becomes the visual cut line marker for the user and the said raised straight edge guide lip of the said present invention provides the perfect straight edge guide that never becomes damaged through operation with the said chosen portable cutting power tool.
The thin “body” design maximizes structural contact of the said present invention with the said baseplate while keeping the said present invention as lightweight as is possible for manufacturing; also, the body of the said present invention functions as a hand rest area for which to apply grip pressure to the said complete cutting guide to the work piece to be cut. The combination baseplate new edge/non-skid grip strip of the said complete cutting guide limits chipping and movement of the work piece being cut; more specifically when using a portable power circular saw, the cutting blade rotates upwards through the work piece to be cut and normally creates chipping to the cut edge—the full contact grip of the said non-skid tape strips with the surface of the work piece to be cut significantly restricts the chipping caused by the cutting blade.
The lack of clamping allows for rapid “set-up” upon any work piece to be cut; the design of the said complete cutting guide allows for freedom of placement upon any work piece to be cut and is not restricted to “certain angles of cutting” that other guides are limited to.

5. (original) A cutting guide according to claim 1, whereby a said present invention has inset slotted nut and bolt members for semi-permanent attachment to a said baseplate and can be freely removable enabling the said present invention to form a new combination with a new said baseplate hence creating an entirely new customized complete cutting guide.
A said inset slotted nut and bolt member located near the end of each longitudinal axis of the said present invention; a said slotted nut and bolt member of which is positioned between and perpendicular to the said two raised straight edge guide lips along the lateral axis of the said present invention. The said slotted nut and bolt member has two parts to its body design, an upper and lower as will be described as the following: the lower half of the said inset slotted nut and bolt member has an opening of which runs mostly along the length of the slot; the said opening is equal to the diameter of the threaded body of the bolt member; the said opening creates a ledge along the lower half of the body of the slotted member, a said ledge of which is less than the width of the said inset slotted nut and bolt member itself, but equal in distance to the width of the square nut member; the upper half of the said inset slotted nut and bolt member houses the said square nut member and is equal in cross diameter to the width of the said square nut member. The said upper half of the slot allows the said square nut to fit tightly within the opening, also the said square nut member can move freely along the lateral axis within the said inset slotted nut and bolt member. The said opening of the said lower half of the said inset slotted nut and bolt member allows for the said bolt member to move freely along the lateral axis of such. Most importantly is the function of the said inset slotted nut and bolt member is the permanent washer created by the said ledge of the lower half of the said slotted member; the said ledge is sandwiched between the said square nut member and the said bolt member thus creating the anchor point for attachment of the said present invention to the said baseplate. Also important to the function of the said inset slotted nut and bolt member is the lateral mobility of the said square nut member within the said inset slotted nut and bolt member enabling the provision of the ability to make lateral adjustments of the said present invention while anchored to the said baseplate material. This essentially allows the user to create a new straight said cutting blade marker edge if incidental damage occurs to this edge without discarding the said baseplate.

6. (original) A cutting guide according to claim 1, whereby the members of the said inset slotted nut and bolt member are as follows: the nut member must be a square nut member, the inset slotted member of which accepts the square nut is of exact width dimensions to that of the said square nut member, the said inset slotted member runs perpendicular and between the two said raised straight edge cutting guide lips of the said A-part, the bottom of the said inset slotted member is wide enough to accept the body of the bolt member thus acting as a “built-in washer” for the said square nut member and said bolt member; and there will be two said inset slotted members per each lineal foot of run of the apparatus created from the design template of the said present invention. The said bolt member is inserted through a pre-drilled hole made through the said baseplate; such hole is marked by tracing the slot dimension to the said baseplate; the said hole can be pre-drilled at any point along this traced marking, however a mid-point selected between the said raised straight edge guide lips is ideal. The head of the said bolt member must be counter-sank into said baseplate member so as not to damage the work piece to be cut and nor hinder the function of the said C-part members.

7. (original) A cutting guide according to claim 1, whereby said complete cutting guide is created by using the said present invention as the integral apparatus; the said baseplate attached thereto is comprised of wood-based material. Our testing has shown that a baseplate composed of plastic has certain limitations; the sharpness of the cutting blade is significant when cutting most of the plastic materials we tested, most new sharp blades performed well, however, most of the used blades caused significant damage to the newly formed cutting blade guide edge. The results of using a less than sharp blades were much less significant when we used wood-based materials to form the said baseplate. These results have led us to believe that the baseplate required should be of wood-based material to give the most cost benefit and best overall results for the consumer/user.

8. (original) A cutting guide according to claim 1, whereby said complete cutting guide is created by using the said present invention as the integral apparatus; the said complete cutting guide is kept level upon the work piece to be cut; simply, it is required that both said C-parts have a balanced and equal height-to-work-piece ratio when the said complete cutting guide is placed upon the work piece to be cut. Many work pieces will be large enough to have contact with both C-part strips and remain on the level. However it is required for smaller work pieces to be cut, that material of equal height to the smaller work piece to be cut be placed in contact with the opposing non-skid edge of the said complete cutting guide; in doing so, the said complete cutting guide is kept in balance with relation to the work piece to be cut and hence the cutting blade is at perpendicular to the work piece to be cut.
